(19) United States
(12) Patent Application Publication
(10) Pub. No.: US 2017/0157561 A1
(43) Pub. Date: Jun. 8, 2017

(54) METHOD AND SYSTEM FOR THE CATALYTIC CLEANING OF EXHAUST GAS

(71) Applicants: ThyssenKrupp Industrial Solutions AG, Essen (DE); ThyssenKrupp AG, Essen (DE)

(72) Inventors: Kathrin ROHLOFF, Hamburg (DE); Melanie FLASSPOHLER, Dortmund (DE); Timo STENDER, Fröndenberg (DE)

(73) Assignees: ThyssenKrupp Industrial Solutions AG, Essen (DE); ThyssenKrupp AG, Essen (DE)

(21) Appl. No.: 15/316,283

(22) PCT Filed: Jun. 5, 2015
(86) PCT No.: PCT/EP2015/062576

§ 371 Date: Dec. 5, 2016

(30) Foreign Application Priority Data
Jun. 10, 2014 (DE) 10 2014 108 150.1

(51) Int. Cl. B01D 53/86; F23J 15/02

(52) U.S. Cl. CPC B01D 53/8696; B01D 53/8656; B01D 53/869; F23J 15/02

(57) ABSTRACT

A method of closed-loop control of a catalytic operation to clean offgas from a plant for processing of a raw material may involve determining an offgas composition downstream of a catalyst and varying an entrance temperature of the offgas entering the catalyst based on the determined composition. By varying the entrance temperature, the offgas composition downstream of the catalyst may be brought or maintained within a target range. A plant for performing such methods may include a processing apparatus for a raw material that produces an offgas, a catalyst, a measuring apparatus for determining a composition of the offgas downstream of the catalyst, a temperature-affecting apparatus for varying the entrance temperature of the offgas entering the catalyst, and a closed-loop control apparatus that actuates the temperature-affecting apparatus based on the composition of the offgas downstream of the catalyst.

The invention relates to a method of closed-loop control of a catalytic operation to clean offgas from a plant for processing of a raw material, especially of cement, lime and/or minerals. The invention further relates to a plant suitable for performance of the method.

Plants which are used in the primary industry for mechanical and/or thermal processing of a material, for example of cement clinker, lime or minerals, are increasingly being equipped with apparatuses for cleaning of the offgases formed in the processing. This is supposed to reduce the concentration of particular pollutants in the offgas before it is released into the environment.

For example, DE 197 20 205 A1 discloses a method of cleaning offgas laden with nitrogen oxides, in which the offgas is preheated in a heat exchanger, then reheated by means of a burner and subsequently supplied to a reduction catalyst with addition of a reducing agent. The hot offgases leaving the reduction catalyst are utilized to charge one of two heat storage means. During this time, the other heat storage means serves as heat exchanger for the offgas to be supplied to the reduction catalyst. As a result of cyclical switching of the two heat storage means, one of the heat storage means is thus always being charged, while the other heat storage means is being utilized as heat exchanger for preheating the offgas.

DE 197 20 205 A1 further discloses the possibility of a combination of the reduction catalyst with an oxidation catalyst downstream thereof, by means of which organic compounds and especially furans and dioxins are to be removed simultaneously from the offgas.

Proceeding from this prior art, it was an object of the invention to improve the treatment of offgas from a plant for processing raw materials with regard to the lowering of the pollutant levels in a very simple manner.

This object is achieved by a method as claimed in claim 1 and a plant as claimed in claim 11. Advantageous embodiments of the method of the invention and advantageous configurations of the plant of the invention are the subject of the further claims and will be apparent from the description of the invention which follows.

The invention is based on the finding that the temperature of the offgas which enters a catalyst of a plant for processing of a raw material is crucial to the action of the catalyst and hence to the degree of lowering of the corresponding pollutant levels by the catalyst.

The basic idea of the invention is therefore an adjustment of the temperature of the offgas entering the catalyst such that a very substantially optimal catalyst action is established. In this context, however, it should not (or at least not primarily) be the offgas temperature that serves as controlled variable, but instead the offgas composition downstream of the catalyst (i.e. beyond the catalyst in flow direction of the offgas), which means that changes, for example a change in the offgas composition, which affect the optimal offgas temperature for the catalyst action can be taken into account. The intention is thus not (but at least not primarily) static closed-loop control of the offgas temperature to a predefined fixed target temperature. Instead, dynamic closed-loop control of the offgas temperature within a temperature range as a function of the actual composition and other parameters of the cleaned offgas is envisaged.

Accordingly, in a method of the invention for closed-loop control of a catalytic operation to clean offgas from a plant for processing of a raw material (preferably a raw material in the coal and steel industry and more preferably of cement, lime and/or minerals), an offgas composition is ascertained downstream of a catalyst and the (target) entrance temperature of the offgas on entry into the catalyst is varied as a function of the result ascertained such that the offgas composition downstream of the catalyst is within a target range.

A plant suitable for performance of the method of the invention comprises at least
a processing apparatus for a raw material (for example in the coal and steel industry), especially cement, lime and/or minerals, that produces an offgas,
a (single- or multilayer) catalyst,
a measuring apparatus for ascertaining an offgas composition downstream of the catalyst,
a temperature-affecting apparatus for varying the entrance temperature of the offgas on entry into the catalyst and
a closed-loop control apparatus which actuates the temperature-affecting apparatus as a function of the result ascertained such that the offgas composition downstream of the catalyst is within a target range.

In a preferred embodiment of the method of the invention, it may be the case that a variability that affects or reflects an offgas composition and/or an offgas temperature upstream of the catalyst (i.e. before the catalyst in flow direction of the offgas) is also ascertained and utilized for an adjustment of the offgas temperature. In this way, changes in the operating conditions of the plant (“variability”) that affect the offgas temperature and/or the offgas composition can be proactively taken into account in order to adjust the (target) offgas temperature in terms of a very advantageous catalyst action. More preferably, those variabilities which have a relevant effect on the concentration of carbonaceous compounds in the offgas can be ascertained.

For this purpose, the plant of the invention may have a measurement apparatus for ascertaining such a variability which affects or reflects an offgas composition or an offgas temperature upstream of the catalyst.

In a further-preferred embodiment of the method of the invention, it may be the case that the entrance temperature is varied by means of a greater or lesser degree of auxiliary firing, a greater or lesser degree of mixing-in of a fluid, especially of a gas having a temperature differing from and especially exceeding (“hot gas”) the local temperature of the offgas, and/or a greater or lesser degree of heat exchange with any heat exchange medium. For this purpose, the temperature-affecting apparatus of the plant of the invention may be an auxiliary heater, a mixing-in device for a fluid, especially a (hot) gas, and/or a heat exchanger. The (hot) gas may especially be a dedusted gas bypass from the clinker production.

The plant of the invention may also comprise further plants or plant components that do not serve for treatment of a raw material. More particularly, for a temperature-affecting apparatus in the form of a mixing-in device or a heat exchanger, it is possible to utilize a component and especially a material or fluid stream included in the component from a plant or apparatus for a different use, for example in the power plant industry (especially combustion of materials (especially raw materials, but also, for example, waste) for generation of electrical energy). These plants or apparatuses for a different use may, for example, serve for drying, torrefaction and/or pyrolysis of a carbonaceous material or fluid stream in particular.

The heat exchanger used in the temperature-affecting apparatus may especially be a material preheater arranged between the processing apparatus and the catalyst, in which heat is transferred from the offgas to the raw material. In this case, the material preheater may preferably comprise one or more heat exchanger stages, in which case a first feed for the raw material is arranged beyond a heat exchanger stage in the direction in which the raw material passes through the material preheater, a second feed for the raw material, based on the direction in which the raw material passes through the material preheater, is arranged upstream of this heat exchanger stage, and a control unit for adjusted division of the raw material between the first feed and the second feed is provided.

Further preferably, it may be the case that the entrance temperature is varied within a temperature range between 150° C. and 600° C., preferably between 180° C. and 500° C. and more preferably between 240° C. and 450° C. In this case, the variable temperature range may correspond to all or a sub-range of the temperature ranges quantified. The actual choice of the variable temperature range within the quantified temperature ranges specified may especially depend on the catalyst type, the pollutant levels to be lowered and the offgas matrix.

The plant of the invention preferably includes an oxidation catalyst which may especially be intended for lowering the levels of carbon monoxide (CO) and/or organic hydrocarbons (CₓH_{y}) present in the offgas, and possibly also of dioxins and furans.

The plant of the invention may advantageously also comprise at least two series-connected (single- or multilayer) catalysts which are especially also different catalyst types and hence differ at least with regard to the pollutant levels to be lowered and generally also with regard to their structure. More preferably, as well as a (single- or multilayer) oxidation catalyst, a (single- or multilayer) reduction catalyst may also be provided. In this way, it is especially possible to achieve lowering of carbon monoxide, organic hydrocarbon and nitrogen oxide (NOₓ) levels. More preferably, it may be the case that the reduction catalyst is downstream of the oxidation catalyst in flow direction of the offgas.

A reduction catalyst in a plant of the invention may preferably have an upstream metering apparatus for a reducing agent, by means of which the preferably ammonia-containing reducing agent should be introduced into the offgas stream with maximum fineness and uniformity. The introduction of the reducing agent can be controlled by means of the closed-loop control apparatus, likewise as a function of the measured offgas composition downstream of the catalyst. If the reduction catalyst has a downstream oxidation catalyst, the metering apparatus for a reducing agent is preferably arranged between them, in order to avoid contacting of the oxidation catalyst with the reducing agent.

In the case of at least two catalysts, it may preferably be the case that the temperature-affecting apparatus is arranged upstream or between the two (or how) catalysts. More preferably, a second temperature-affecting apparatus may also be provided, in which case the closed-loop control apparatus also actuates the second temperature-affecting apparatus as a function of the result ascertained such that the offgas composition downstream of the catalyst directly downstream of the second temperature-affecting apparatus or downstream of both catalysts is within a target range. More particularly, it is thus possible to provide, upstream of each catalyst, a temperature-affecting apparatus, by means of which, controlled by the closed-loop control apparatus, it is possible to vary a very substantially optimal offgas temperature with regard to the degree of lowering on entry into the catalyst directly downstream. In this case, the closed-loop control may be based on ascertainment of the offgas composition downstream of all catalysts. Also possible are ascertainments of the offgas compositions and closed-loop control operations of the individual temperature-affecting apparatuses downstream of the individual catalysts that are based thereon.

In a preferred embodiment of the method of the invention, it may further be the case that a measurement that reflects an offgas composition or an offgas temperature, for example upstream of the catalyst, is conducted. This allows changes in the offgas composition or in the offgas temperature there to be ascertained directly, leading to a corresponding proactive adjustment of the (target) temperature of the offgas entering the catalyst. For this purpose—as well as temperature measurements—it is especially possible to conduct concentration measurements of carbon monoxide, oxygen, hydrocarbons and/or nitrogen oxides.

One variability which affects an offgas composition, but especially an offgas temperature upstream of the catalyst, and which may be ascertained may preferably be the heat exchange performance of a heat exchanger intended for heat exchange with the offgas (for example via the ascertainment of entrance and exit temperatures or temperature differentials). The heat exchanger may, for example, be an offgas preheater in which the offgas is preheated prior to entry into the catalyst by heat exchange with another medium, especially a gas, for example the offgas in another section of the offgas line of the plant, another offgas from the plant or cooling air heated beforehand in a cooling functionality. In addition, the heat exchanger may be a material preheater in which the offgas, before it enters the catalyst, is utilized in order to heat another medium. Material preheaters of this kind are utilized, for example, in plants for cement clinker production, in order to preheat cement raw meal before it is supplied to a kiln, especially rotary kiln, in which the cement clinker is burnt, through transfer of heat from the offgas leaving the kiln.

Heat exchangers can also be designed with closed-loop control, as a result of which they can serve as temperature-affecting apparatuses in the plant of the invention. Heat exchange performance of a material preheater can be configured such that it can be affected, for example, by virtue of the material preheater comprising one or more heat exchanger stages, in which case a first feed for the medium to be heated, based on the direction in which the medium passes through the heat exchanger, is arranged beyond a heat exchanger stage, and a second feed for the medium, based on the direction in which the medium passes through the heat exchanger, is arranged upstream of this heat exchanger stage, and the control apparatus is used for demand-adjusted division of the medium to be supplied between the first feed and the second feed. Depending on what proportion of the medium to be preheated passes through which and how many heat exchanger stages, it is possible to adjust the heat transfer from the offgas to the medium and hence the temperature of the offgas downstream of the material preheater.

The heat exchanger stage that can be (partly) bypassed if required by the medium to be preheated is preferably that which the medium passes through first in the course of passage through the material preheater. In this way, it is possible to achieve the effect that the heat exchange from the offgas to the medium occurs primarily in the heat exchanger stage(s) closer to an apparatus for processing of the medium (for example a (rotary) kiln in a plant for cement clinker production). This can have a positive effect on pressure drops in the material preheater. The material preheater in this case may take the form of a multistage cyclone preheater (for example with four, five or six stages), the construction and way of working of which are common knowledge.

In addition, a corresponding variability which can be ascertained is a flow rate of a medium used in the processing of the raw material. This may, for example, be the flow rate of the cement raw meal to be processed in the plant or the fuel converted (overall or locally) in the plant.

A further variability that affects an offgas composition or an offgas temperature upstream of the catalyst and which may be ascertained is a performance of an apparatus used in the processing of the raw material. This apparatus may, for example, be a ventilator or a raw mill for grinding of cement raw meal, for example.

In a further preferred configuration of the method of the invention, it may additionally be the case that the catalyst action of the catalyst is recorded as a function of the result ascertained. This can enable ascertainment of a catalyst action excluding the effect of the temperature of the offgas on entry into the catalyst. More particularly, this enables recognition of a temperature-independent decrease in activity of the catalyst which may be caused, for example, by the ad- or absorption of activity-lowering substances, for example ammonium bisulfate.

Such a recognition of a decrease in activity of the catalyst can enable, when the catalyst action goes below a limit, the catalyst is baked temporarily, which involves overriding or suspending the closed-loop control based on the offgas composition downstream of the catalyst. It is thus possible in a temporary manner to slow, stop or (partly) reverse any decrease in catalyst activity through an increase in the offgas temperature decoupled from the closed-loop control based on the offgas composition downstream of the catalyst, by thermally decomposing or desorbing activity-lowering substances, for example.

The use of indefinite articles (“a”), especially in the claims and the part of the description that elucidates them, should be understood as such and not construed to mean “one”. Such a use should thus be understood such that at least one of the elements identified thereby is present and more than one may be present.

The invention is elucidated in detail hereinafter with reference to a working example illustrated in the drawing. The drawing shows:

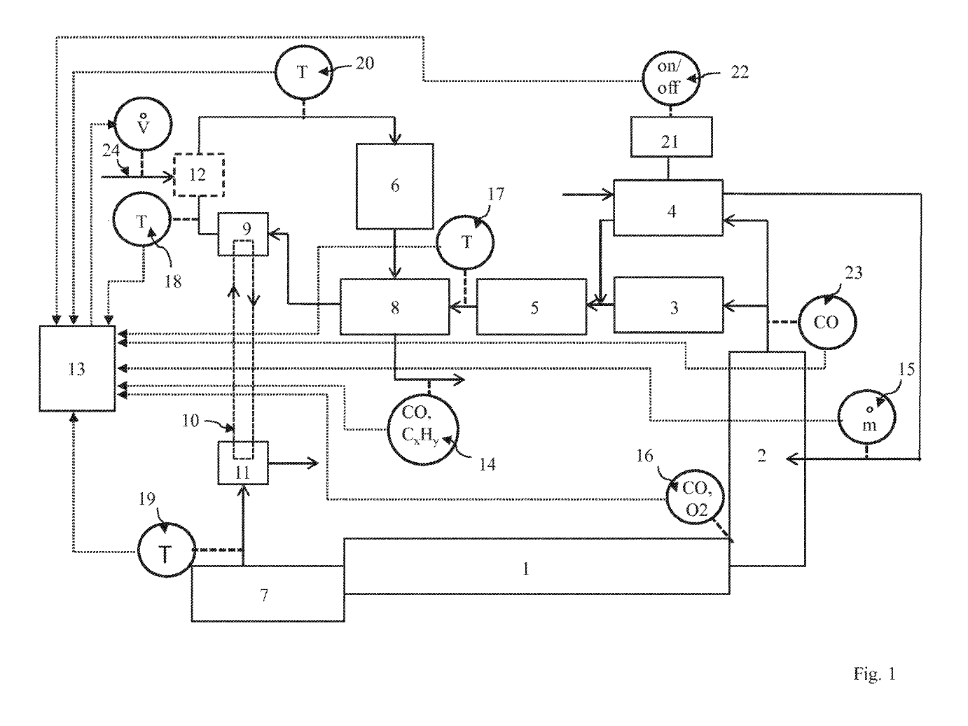

FIG. 1: a plant of the invention in a schematic view.

The plant shown in FIG. 1 is a plant for production of cement clinker. It comprises a rotary kiln 1 in which finely ground cement raw meal which has been preheated beforehand in a material preheater 2 by the offgas which has left the rotary kiln 1 is burnt to give cement clinker. The offgas which has left the material preheater 2 then either flows through a cooling tower 3 or is—at least partly—utilized for drying of the cement raw meal during grinding in a raw mill 4. Subsequently, the offgas is dedusted in a dust filter 5 and sent to a catalyst apparatus 6 for offgas cleaning. In addition, the plant also comprises a clinker cooler 7 in which the cement clinker discharged from the rotary kiln 1 is cooled by means of cooling air.

The catalyst apparatus 6 may comprise one or more catalysts, especially an oxidation catalyst and/or a reduction catalyst. Each of the catalysts may have one or more layers. Merely by way of example, in the present working example of the catalyst apparatus 6, only one oxidation catalyst is provided, by means of which, in particular, lowering of the concentrations of carbon monoxide (CO) and organic hydrocarbons (CₓH_{y}) in the offgas is to be achieved.

The gas which has left the dust filter, prior to entry into the catalyst apparatus 6, is first conducted through a first heat exchanger 8 designed as a gas-gas heat exchanger, in which this gas is preheated by heat exchange with the offgas leaving the catalyst apparatus. The temperature differential between the offgas which has left the catalyst apparatus 6 and the offgas which has left the dust filter 5 that enables such heat transfer results from an increase in temperature for the offgas in the catalyst apparatus 6 owing to exothermic oxidation of, in particular, carbon monoxide and organic hydrocarbons according to the following reaction equations:

2CO+O₂→2CO₂;

CₙHₘ+(n+m/4)O₂→nCO₂+m/2H₂O.

The offgas which has left the first heat exchanger 8 is subsequently conducted through a second heat exchanger 9. Further preheating of the offgas by heat exchange with a transfer medium 10 can be achieved therein. For this purpose, the transfer medium 10 has been heated beforehand in a third heat exchanger 11 by cooling air which has left the clinker cooler 7.

After the second heat exchanger 9, the offgas flows through a temperature-affecting apparatus in the form of an auxiliary heater 12 before it then enters the catalyst apparatus 6. In the auxiliary heater 12, the offgas can be heated further. For this purpose, a fuel, for example natural gas, is combusted and the heat energy thus generated is transferred very substantially to the offgas.

Closed-loop control of the fuel converted in the auxiliary heater 12 and hence the temperature of the offgas on entry into the catalyst apparatus 6 is effected by means of a closed-loop control apparatus 13 as a function of the offgas composition, specifically the concentrations of carbon monoxide and organic hydrocarbons, which is measured by means of a first measurement apparatus 14 integrated into the offgas line downstream of the catalyst apparatus 6 and also downstream of the first heat exchanger 8.

Depending on the configuration of the catalyst apparatus 6, sufficiently high degrees of lowering are only achieved above a particular limiting temperature. This limiting temperature can vary considerably depending on the offgas composition. In addition, there may be an upward restriction in the offgas temperature, in order firstly to avoid any adverse effect on the plant components and especially on the catalyst apparatus as a result of overheating, and secondly in order to minimize the fuel requirement of the auxiliary heater 12. A temperature range thus arises for the offgas entering the catalyst apparatus 6, within which the offgas temperature should be varied by adjusted heating by the auxiliary heater 12, in order to achieve high degrees of lowering for carbon monoxide and organic hydrocarbons. In this case, the degrees of lowering to be achieved, however, need not correspond to what is technically feasible, but may instead also be guided by emissions regulations.

In the operation of the plant, a multitude of variabilities affect the offgas composition and also the offgas temperature. These variabilities may be disturbance and/or auxiliary variables for the closed-loop control of the fuel supply 24 and hence the temperature of the offgas on entry into the catalyst apparatus 6. The variabilities include the flow rate of the cement raw meal supplied from the raw mill 4 to the material preheater 2 and hence the rotary kiln 1, which is determined by means of a corresponding second (flow rate) measuring apparatus 15. The varying composition of the cement raw meal is another variability of this kind. In addition, it is possible by means of a third (offgas composition) measuring apparatus 16 to ascertain the offgas composition, especially the concentration of carbon monoxide and oxygen of the offgas leaving the kiln, and by means of a fourth (offgas composition) measuring apparatus 23 to ascertain the offgas composition, especially the concentration of carbon monoxide of the offgas leaving the material preheater 2. Moreover, the temperature of the offgas leaving the dust filter 5 and hence also the potential heat transfer performance of the first heat exchanger 8 can be ascertained by means of a fifth (temperature) measuring apparatus 17. By means of a sixth (temperature) measuring apparatus 18, it is additionally possible to ascertain the temperature of the offgas between the second heat exchanger 9 and the auxiliary heater 12, and, by means of a seventh (temperature) measuring apparatus 19, it is possible to ascertain the temperature of the cooling air which has left the clinker cooler 7 before it is supplied to the third heat exchanger 11 (and hence a potential heat exchange performance of the third heat exchanger 11).

Further variabilities, especially relating to the offgas composition, may arise from the possible integrated operation of the cooling tower 3 and the raw mill 4, wherein at least a portion of the offgas is conducted through the raw mill 4. For example, in integrated operation, the oxygen content in the offgas may be higher than in direct operation (i.e. without supply of offgas to the raw mill 4), which can have a positive effect on the oxidation in the oxidation catalyst of the catalyst apparatus 6. In addition, the partial water vapor pressure may differ between direct and integrated operation. A higher water vapor content in the offgas may have a tendency to reduce the degrees of lowering. Operation of the raw mill 4 fundamentally also affects the pollutant concentrations in the offgas, since both outgassing and chemical and physical adsorption processes of pollutants take place, which could be lowered in the catalyst apparatus 6, but could also affect the activity of the catalyst. For example, sulfur dioxide is converted by temperature-dependent catalytic oxidation to sulfur trioxide and subsequent reaction with ammonia to ammonium bisulfate. Ammonium bisulfate can adversely affect a catalyst activity. In the operation of the raw mill 4, sulfur dioxide present in the offgas, however, is incorporated to a relevant degree and hence removed from the offgas. This could enable contacting of the catalyst apparatus 6 with lower offgas temperatures without any significant decrease in the degree of lowering as a result. Moreover, in the operation of the raw mill, outgassing of hydrocarbons is possible, such that higher concentrations thereof can occur in the offgas in integrated operation.

Operation of the raw mill 4 and possibly also the specific performance of a drive 21 of the raw mill 4 can be ascertained via an eighth (performance) measuring apparatus 22 and taken into account in the closed-loop control.

All these disturbance variables can be utilized to proactively affect the closed-loop control of the fuel conversion in the auxiliary heater 12, by drawing conclusions about the offgas composition and the offgas temperature between the second heat exchanger 9 and the auxiliary heater 12 based on the disturbance and/or auxiliary variables measured and controlling the fuel conversion in the auxiliary heater 12 by closed-loop control such that, based on the predicted offgas composition and offgas temperature, the introduction of heat to be established for the attainment of the envisaged degree of lowering is likely to be achieved by means of the auxiliary heater 12, and hence the target temperature of the offgas on entry into the catalyst apparatus 6.

The actual attainment of the (variable) target temperature of the offgas on entry into the catalyst apparatus 6, determined by the proactive and emissions-based closed-loop control, is monitored by means of a ninth (temperature) measuring apparatus 20 (measurement of the actual temperature) and used in an internal control loop for closed-loop control of the fuel conversion by means of the closed-loop control apparatus 13.

In the closed-loop control of the above-described working example, the fuel conversion in the auxiliary heater 12 is the manipulated variable for the closed-loop control of the temperature of the offgas on entry into the catalyst apparatus 6 and hence the offgas composition downstream of the catalyst apparatus 6. The manipulated variable is affected not only by the controlled variable, i.e. the offgas composition downstream of the catalyst unit 6 measured by means of the first measurement apparatus 14, but also by the disturbance variables described, which are caused by the variabilities of the operation of the plant. It is also possible, alternatively or additionally to the fuel conversion in the auxiliary heater 12, to utilize at least some of the variabilities as manipulated variables, such that it is possible, for example, to adjust the heat transfer from the cooling air originating from the clinker cooler 7 to the offgas by means of a variable configuration of the heat exchange system comprising the second heat exchanger 9 and the third heat exchanger 11. In addition, it is possible, for example, to vary the temperature of the offgas downstream of the dust filter 5, ascertained by means of the fourth measurement apparatus 17, by altering an injection of water in the cooling tower 3.

### LIST OF REFERENCE NUMERALS

1. rotary kiln
2. material preheater
3. cooling tower
4. raw mill
5. dust filter
6. catalyst apparatus
7. clinker cooler
8. first heat exchanger
9. second heat exchanger
10. transfer medium
11. third heat exchanger
12. auxiliary heater
13. closed-loop control apparatus
14. first measuring apparatus
15. second measuring apparatus
16. third measuring apparatus
17. fifth measuring apparatus
18. sixth measuring apparatus
19. seventh measuring apparatus
20. ninth measuring apparatus
21. drive
22. eighth measuring apparatus
23. fourth measuring apparatus
24. fuel supply

1.-20. (canceled)

21. A method of closed-loop control of a catalytic operation to clean offgas from a plant for processing a raw material, the method comprising:
determining a composition of an offgas downstream of a catalyst; and
varying an entrance temperature of the offgas entering the catalyst based on the composition of the offgas downstream of the catalyst so as to bring or maintain the composition of the offgas downstream of the catalyst within a target range.

22. The method of claim 21 further comprising determining a variability that affects or reflects the composition of the offgas or a temperature of the offgas downstream of the catalyst.

23. The method of claim 21 wherein varying the entrance temperature is effected by at least one of auxiliary firing, mixing-in of a fluid, or exchanging heat with a heat exchange medium.

24. The method of claim 21 wherein the entrance temperature of the offgas is varied between 150° C. and 600° C.

25. The method of claim 21 further comprising conducting a measurement that reflects a composition or a temperature of the offgas upstream of the catalyst.

26. The method of claim 21 further comprising determining a heat exchange performance of a heat exchanger used with the offgas, wherein the heat exchange performance is a variability that affects a composition or a temperature of the offgas upstream of the catalyst.

27. The method of claim 21 further comprising determining a flow rate of a medium used in processing the raw material, wherein the flow rate is a variability that affects a composition or a temperature of the offgas upstream of the catalyst.

28. The method of claim 21 further comprising determining a performance of an apparatus used to process the raw material, wherein the performance of the apparatus is a variability that affects a composition or a temperature of the offgas upstream of the catalyst.

29. The method of claim 21 further comprising recording a catalyst action of the catalyst as a function of the determined composition.

30. The method of claim 21 wherein when a catalyst effect drops below a limit, the catalyst is baked, which comprises overriding or suspending the closed-loop control based on the composition of the offgas downstream of the catalyst.

31. A plant comprising:
a processing apparatus for a raw material that produces an offgas;
a catalyst;
a measuring apparatus for determining a composition of the offgas downstream of the catalyst;
a temperature-affecting apparatus for varying an entrance temperature of the offgas entering the catalyst; and
a closed-loop control apparatus that actuates the temperature-affecting apparatus based on the composition of the offgas downstream of the catalyst so as to bring or maintain the composition of the offgas downstream of the catalyst within a target range.

32. The plant of claim 31 wherein the measuring apparatus is a first measuring apparatus, the plant further comprising a second measuring apparatus for determining a variability that affects a composition or a temperature of the offgas upstream of the catalyst.

33. The plant of claim 31 wherein the temperature-affecting apparatus comprises at least one of an auxiliary heater, a mixing-in device for a fluid, or a heat exchanger.

34. The plant of claim 31 further comprising a material preheater disposed between the processing apparatus and the catalyst, wherein the material preheater transfers heat from the offgas to the raw material.

35. The plant of claim 34 wherein the material preheater comprises one or more heat exchanger stages, wherein a first feed for the raw material is disposed beyond a heat exchanger stage in a direction in which the raw material passes through the material preheater, wherein based on the direction in which the raw material passes through the material preheater a second feed for the raw material is disposed upstream of the heat exchanger stage, wherein the plant further comprises a control unit for dividing the raw material between the first feed and the second feed.

36. The plant of claim 31 wherein the catalyst comprises an oxidation catalyst.

37. The plant of claim 36 wherein the temperature-affecting apparatus is a first temperature-affecting apparatus, the plant further comprising a second temperature-affecting apparatus, wherein the closed-loop control apparatus actuates the second temperature-affecting apparatus based on the composition of the offgas downstream of the catalyst so as to
bring or maintain the composition of the offgas downstream of the catalyst within the target range, or
bring or maintain a composition of the offgas upstream of the catalyst within a target range.

38. The plant of claim 31 wherein the catalyst is a first catalyst, the plant further comprising a second catalyst connected in series with the first catalyst.

39. The plant of claim 38 wherein the first and second catalysts comprise an oxidation catalyst and a reduction catalyst.

40. The plant of claim 31 further comprising a reduction catalyst that has an upstream metering apparatus for a reducing agent.
